(19) United States
(12) Patent Application Publication
(10) Pub. No.: US 2015/0287128 A1
(43) Pub. Date: Oct. 8, 2015

(54) SYSTEM AND METHOD FOR GENERATING IMAGES OF COMMODITIES

(71) Applicant: KABUSHIKI KAISHA TOSHIBA, Tokyo (JP)

(72) Inventors: Yoshiaki Mizuoka, Kamakura (JP); Masaru Suzuki, Kawasaki (JP)

(21) Appl. No.: 14/731,494

(22) Filed: Jun. 5, 2015

Related U.S. Application Data
(63) Continuation of application No. PCT/JP2012/081677, filed on Dec. 6, 2012.

(51) Int. Cl. G06Q 30/06

(52) U.S. Cl. CPC G06Q 30/0643

(57) ABSTRACT

According to one embodiment, a commodity-image generating system includes a reception unit receiver, an acquisition unit, and synthesis unit synthesizer. The reception unit receiver receives selection information able to specify at least one commodity selected by a user, the quantity in which to purchase the commodity and the unit of the quantity. The acquisition unit acquires at least one commodity image associated with the commodity selected in accordance with the selection information, and quantity information representing the quantity of the commodity included in the commodity image. The synthesis unit synthesizer generates, on the basis of the quantity information, a synthesized image included in composed of the commodity image. The synthesized image reflects the quantity and the unit of the quantity.

### CROSS-REFERENCE TO RELATED APPLICATIONS

This application is a Continuation application of PCT Application No. PCT/JP2012/081677, filed Dec. 6, 2012, the entire contents of which are incorporated herein by reference.

### FIELD

Embodiments described herein relate to a system and method for generating images of commodities.

### BACKGROUND

In recent years, users have more and more opportunity to select any desired merchandise on a screen, as net shopping is more commonly practiced by utilizing networks such as the Internet. In net shopping, the user may select any merchandise he or she wants to buy on the screen of a terminal such as a personal computer, a tablet or a smart phone, and may then follow, if necessary, the procedures such as purchase settlement, without directly seeing or touching the merchandise as would be done in retail shops.

In services involving merchandise selection of this type, a user error such as selection error and/or input error (e.g., inputting a wrong numerical value) may result in obvious errors such as “errors in selecting merchandise” and/or “inputting wrong quantities of the merchandise.” The user can hardly notice such errors even if he or she checks the images of the merchandise and/or a table of the merchandise. Such errors probably go unnoticed, particularly if the user buys large quantities of various merchandise at one time. It is therefore demanded that the above-mentioned error should be prevented even if the user selects merchandise on a screen.

Methods are known by which images of an item of merchandise a user wants to buy are displayed, to help the user recognize the merchandise better or not to be confused, though he or she cannot directly see or touch the merchandise. However, these techniques can hardly enable the user to notice such an error as described above.

Commodity selection may be performed on a screen in various types of service other than net shopping. Alternatively, it may be performed outside networks completely. In either case, such a problem as described above may arise.

Hitherto, no technique has been known which enables a user to confirm, both easily and reliably, which commodity he or she has selected and how many pieces of it he or she has ordered, on a screen.

### BRIEF DESCRIPTION OF THE DRAWINGS

FIG. 1 is a schematic diagram of a merchandise-image generating system according to one embodiment;

FIG. 2 is a flowchart of an exemplary process performed by the merchandise-image generating system according to the embodiment;

FIG. 3 is a diagram showing an example of purchase plan information;

FIG. 4 is a diagram showing an example of image acquisition information;

FIG. 5 is a diagram showing examples of image information;

FIG. 6 is a flowchart of an exemplary process performed in an image-information accumulating device according to the embodiment;

FIG. 7 is a diagram showing an exemplary merchandise image DB;

FIG. 8 is a diagram showing an exemplary merchandise-image quantity information DB;

FIG. 9 is a diagram showing an example of a merchandise-image size information DB;

FIG. 10 is a flowchart of an exemplary process performed in a merchandise-image size calculating device according to the embodiment;

FIG. 11 is a diagram showing an example of merchandise information;

FIG. 12 is a diagram showing an example of a merchandise description;

FIG. 13 is a diagram showing an example of a general merchandise size information DB;

FIG. 14 is a diagram showing an example of merchandise image data;

FIG. 15 is a flowchart of an exemplary process performed in an image information generating device according to the embodiment;

FIG. 16 is a diagram showing an example of the general merchandise image DB;

FIG. 17 is a flowchart of an exemplary process performed in a merchandise-image arranging/synthesizing device according to the embodiment;

FIG. 18 is a diagram showing an example of an image generated;

FIG. 19 is a diagram showing how the images of merchandise bought may be utilized; and

FIG. 20 is another diagram showing how the images of merchandise bought may be utilized.

### DETAILED DESCRIPTION

An object of embodiments is to provide a system and method for generating images of commodities, which enable a user to confirm, both easily and reliably, which commodity has been selected and how many pieces are ordered, on a screen.

In general, according to one embodiment, a commodity-image generating system includes a reception unit receiver, an acquisition unit, and synthesis unit synthesizer. The reception unit receiver receives selection information able to specify at least one commodity selected by a user, the quantity in which to purchase the commodity and the unit of the quantity. The acquisition unit acquires at least one commodity image associated with the commodity selected in accordance with the selection information, and quantity information representing the quantity of the commodity included in the commodity image. The synthesis unit synthesizer generates, on the basis of the quantity information, a synthesized image included in composed of the commodity image and reflecting the quantity and the unit of the quantity.

A commodity-image generating system, or a purchased merchandise-image generating system, according to an embodiment, will be described in detail with reference to the accompanying drawings. In the following description of the embodiment, any identical components that perform the same operation are designated by the same reference number, and description thereof will not be repeated.

The following description is based on the assumption that a user selects an item of merchandise on a screen and then reviews the image generated by the system according to this embodiment (for example, purchased merchandise-image generating system) and then confirms the merchandise he or she has selected. (The embodiment is not limited to this assumption, nevertheless.)

The system according to this embodiment can be incorporated and used in a system that enables the user to select any commodity he or she wants. The embodiment, which is incorporated in, for example, a net-shop application system, will be described below. Nonetheless, the system according to this embodiment is not limited to one incorporated in the net-shop application system. The system can be incorporated in any other application for selecting commodities on a screen.

If the system is one to be incorporated in an apparatus, it may be used in a terminal such as a personal computer, a tablet or a smart phone.

The system according to this embodiment may not be a function or device incorporated in an apparatus. It could also be an independent function or device that communicates with an application such as a net shop through, for example, a LAN, the Internet or cellular network. For example, the net-shop application system in a terminal, such as a personal computer, a tablet or a smart phone, works as a client, and the system according to the embodiment works as a server on the network (e.g., the Internet), and the information about any commodity selected is supplied from the client to the server. The server receives the information and generates an image showing the commodity selected, and then supplies the image to the client.

In the net-shop application system, a typical example of the commodity the user wants is an item the user wants to buy (namely, the merchandise which the user will pay for). Hereinafter, a system will be described in which the user selects, on a screen, merchandise he or she wants to buy.

The commodity the user selects is not limited to this, and may be changed in accordance with the application. For example, it may be a commodity the user can get free of charge or in exchange for some reward points he or she has earned. It may also be a commodity the user gives or lends to someone else. Regardless, the commodity is what the user can select on the screen.

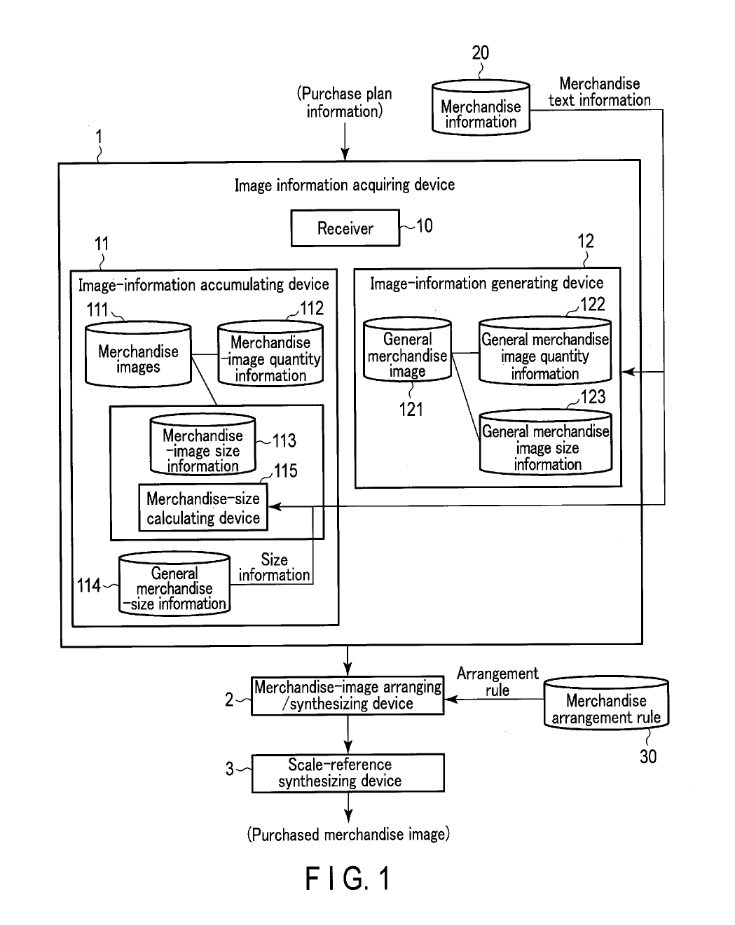

FIG. 1 is a schematic diagram showing the configuration of a merchandise-image generating system (i.e., commodity-image generating system) according to one embodiment.

As shown in FIG. 1, the merchandise-image generating system according to this embodiment includes an image information acquiring device (acquisition unit) 1, a merchandise-image arranging/synthesizing device (synthesizer) 2, and a scale reference synthesis device (scale synthesizer) 3.

Merchandise information (commodity information) 20 may exist anywhere only if the merchandise-image generating system can acquire it. For example, it may be held in the merchandise-image generating system or it may be acquired by the system via a network such as the Internet or LAN. Alternatively, it may be held in the system and may be acquired via the network. This can be said of the merchandise arrangement rule 30.

In this embodiment, the user, for example, selects any merchandise he or she plans to buy and then inputs the purchase quantity (i.e., number of pieces or units), on a prescribed screen (e.g., merchandise selection screen of the net-shop application system (not shown)). The user may select one or more items of merchandise in the merchandise selecting step.

Merchandise is available in various units such as pieces, dozens, bags and boxes. The units are not limited to these, nevertheless. If merchandise is available in units of bags or boxes, it remains unknown how many pieces each bag or box contains. In this case, information may be added, specifying the number of pieces contained in each bag, as “bag (containing 2 pieces), “bag (containing 10 pieces),” or “bag (containing 12 pieces).”

The purchase quantity is the number of units of the commodity which will be purchased. Thus, the quantity {3, pieces} means that three pieces of the commodity shall be purchased, and the quantity {1, bag (containing 2 pieces)} means that two pieces of the commodity shall be purchases.

The unit may be uniquely identified by the merchandise the user has selected to buy, or explicitly selected or input by the user, or both uniquely identified and explicitly selected or input by the user.

The image information acquiring device 1 receives purchase plan information (selection information) (from, for example, the net-shop application system). The purchase plan information contains information about the merchandise to buy and information about the purchase quantity (including the unit data) or specifies the merchandise and the purchase quantity. The purchase plan information may contain information about one or more items of merchandise.

The unit data may be specified from the information about the merchandise to purchase contained in the purchase plan information. Alternatively, the unit may be explicitly contained in the purchase plan information. Still alternatively, the unit data may be both specified from the information about the merchandise to purchase and explicitly contained in the purchase plan information.

This embodiment is described on the assumption that the unit data is contained in the merchandise name. Hence, the unit can be specified from the merchandise name in this embodiment. Nonetheless, this embodiment is not limited thereto.

The image information acquiring device 1 outputs the image information about each item of merchandise based on one or more merchandise items to buy and the purchase quantity of each item of merchandise (and/or the unit data), all included in the purchase plan information (or specified from the purchase plan information). As will be described later in detail, the image information includes images of the merchandise to purchase, and the like.

The merchandise image is a photograph of an item of merchandise, but is not limited to the photograph. It may be generated as a commercial image specific to the merchandise by means of Computer Graphics or drawing software. Alternatively, it may be an image prepared by photographing a hand-drawn illustration.

If no image of merchandise is available, an image of general merchandise similar to the merchandise can be used instead, as will be described later in detail.

As shown in FIG. 1, the image information acquiring device 1 includes a receiver 10, an image-information accumulating device (accumulation unit) 11, and an image-information generating device (generation unit) 12. The image information acquiring device 1 may include a control unit (not shown) configured to control the other components of the device 1.

The receiver 10 receives purchase plan information (selection information) from, for example, the net-shop application system.

The image-information accumulating device 11 can provide image information specific to a particular item of merchandise designated beforehand.

As will be described later in detail, the image-information accumulating device 11 holds merchandise images (commodity images) (111) prepared for the merchandise designated beforehand, merchandise quantities (112) included in the merchandise images, respectively, and the scale information (113) for the respective merchandise images. The image-information accumulating device 11 may not hold the scale information (113).

As shown in FIG. 1, the image-information accumulating device 11 includes a merchandise-image size calculating device (scale information inferring unit) 115, and holds life-size information (114).

The merchandise information 20 is information about general merchandise (for example, information about the specification and content of each item of merchandise), and may include text data representing the trade name or description of the merchandise.

The merchandise-image size calculating device 115 infers the scale information of the merchandise image on the basis of, for example, the text data included in merchandise information 20 and representing the trade name or description of the merchandise, or life-size information (114) about the general merchandise, or both the text data and the life-size information.

The image-information accumulating device 11 may include neither the merchandise-image size calculating device 115 nor the life-size information 114 about the general merchandise.

As will be described later in detail, the image-information generating device 12 can use the image of the general merchandise to generate image information about any given item of merchandise.

In the image information acquiring device 1, the image-information accumulating device 11 and the image-information generating device 12 are used to acquire image information of the merchandise to purchase.

The image information acquiring device 1 may be configured not to include the image-information accumulating device 11 or the image-information generating device 12. For example, the image-information generating device 12 need not be used if all information necessary for the process performed on merchandise the user can select has been prepared.

As will be described later in detail, the merchandise-image arranging/synthesizing device 2 uses the image information acquired by the image information acquiring device 1. That is, the device 2 synthesizes the images of merchandise on the basis of the purchase plan information, thereby reflecting the quantity (and/or unit) of each item of merchandise. Thus, the device 2 generates a synthesized image of each item of merchandise to purchase, the image reflecting the quantity (and/or unit) of the merchandise.

The scale synthesis device 3 uses the scale information for merchandise images, thereby synthesizing a scale reference image (e.g., an object and/or a graduation) with each synthesized image generated by the merchandise-image arranging/synthesizing device 2. As will be described later, the scale synthesis device 3 may not be included in the merchandise-image generating system.

Any synthesized image generated in the merchandise-image generating system according to this embodiment is supplied as an image of an item of merchandise to purchase to a net-shop application system. Not only a synthesized image generated by the scale synthesis device 3 (i.e., merchandise image not having a scale image), but also a synthesized image generated by the merchandise-image arranging/synthesizing device 2 (i.e., merchandise image having a scale image) may be supplied to the net-shop application system. The scale synthesis device 3 may not be provided, or the function of the device 3 may not be used. In this case, the synthesized image generated by the merchandise-image arranging/synthesizing device 2 is provided as an image of the merchandise purchased.

The net-shop application system can display the synthesized image, i.e., image of the merchandise purchased, to a net shopping user, as an image reflecting the outer appearance and/or quantity (and/unit) of the merchandise to purchase, at a specific timing in the net-shop application system (for example, at the time of selecting the merchandise or settling the purchase). The net shopping user reviews this image and can more easily and reliably confirm the merchandise he or she has selected.

The overall flow of the process performed by the embodiment will be explained below.

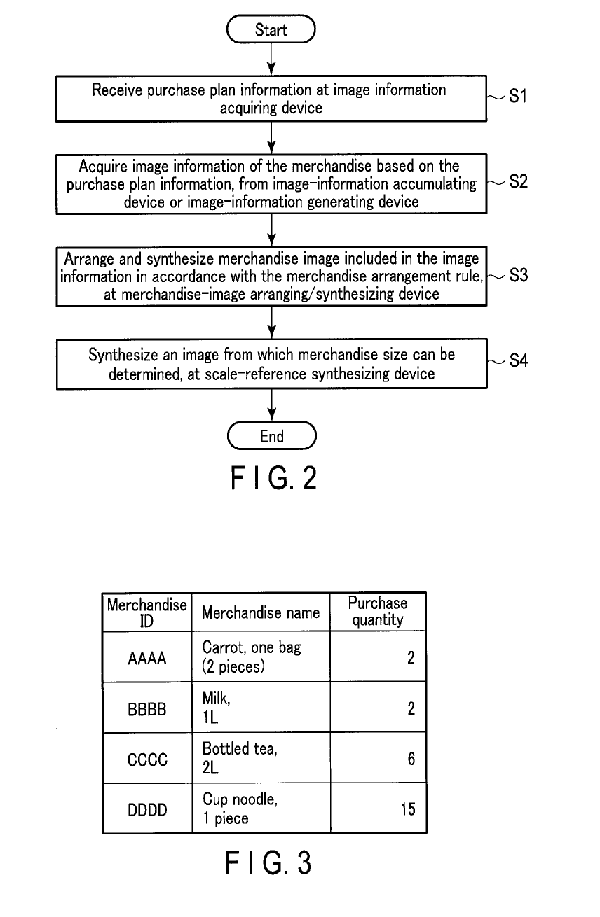

FIG. 2 is an exemplary flowchart showing the overall flow of the process performed in this embodiment.

First, the image information acquiring device 1 receives purchase plan information (Step S1).

FIG. 3 shows an example of the description of the purchase plan information that the image information acquiring device 1 has received.

In the example of FIG. 3, each entry in the purchase plan information is included in “merchandise ID,” i.e., identifier that uniquely identifies a merchandise, “merchandise name” i.e., name of the merchandise, and “purchase quantity” representing the quantity in which to purchase the merchandise. In this embodiment, however, the purchase plan information is not limited to this. Rather, purchase plan information only needs to identify the merchandise uniquely and represent the purchase quantity (or the quantity and the unit).

In the example of FIG. 3, the merchandise of merchandise ID=AAAA has merchandise name “carrot, one bag (2 pieces).” The merchandise name specifies that the unit is “bag.” In addition to, or instead of, the unit specified in the merchandise name, an item of “unit” may be added in each entry.

The purchase plan information may further include the description of the merchandise. Moreover, the purchase plan information may not include the merchandise name if the merchandise is identified by the merchandise ID only.

If the unit in which to purchase or select an item of merchandise is two or more pieces as in the example of FIG. 3, i.e., merchandise “carrot, one bag (2 pieces), two or more pieces of the merchandise will be actually purchased. Nonetheless, “one bag (one piece)” can be set as the merchandise name.

Referring back to FIG. 2, the image information acquiring device 1 receives the image acquisition information about each item of merchandise, which is based on the purchase plan information. Then, the image information of the merchandise is acquired from the image-information accumulating device 11 or the image-information generating device 12 (Step S2).

In this embodiment, the image information acquiring device 1 divides the purchase plan information included in merchandise names and purchase quantities into combinations each included in one item of merchandise. The resultant information is the image acquisition information the image information acquiring device 1 will input to the image-information accumulating device 11 or the image-information generating device 12. That is, an inquiry is repeatedly made to the image-information accumulating device 11 or the image-information generating device 12 a number of times equal to the number of items of merchandise. Thus, an inquiry is made for each item of merchandise. This embodiment is not limited to this, nevertheless. Instead, image information covering two or more items of merchandise may be asked for at one time.

The process of dividing the purchase plan information into one or more image acquisition information items may be performed in the receiver 10 or may be performed in a dividing unit provided.

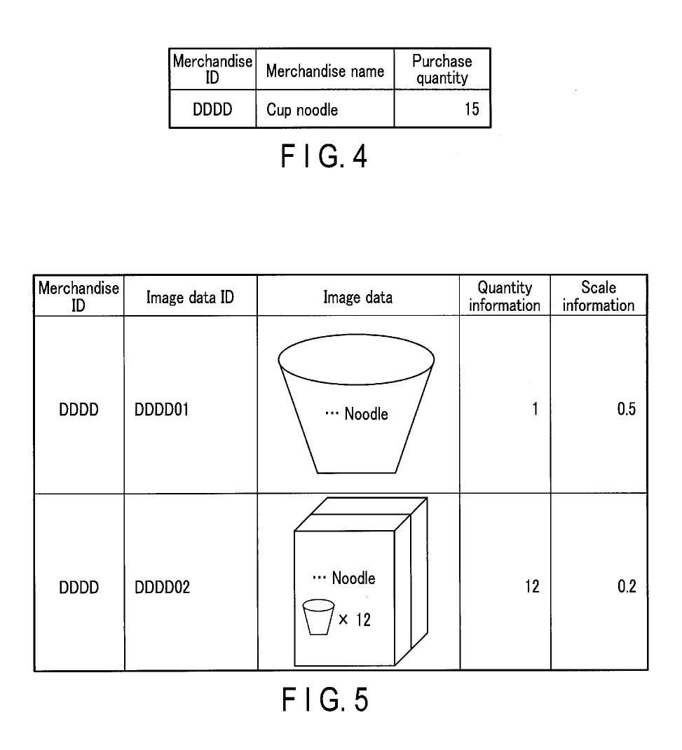

FIG. 4 shows an example of image acquisition information.

In the example of FIG. 4, the entry of the image acquisition information is included in “merchandise ID,” “merchandise name” and “purchase quantity.” The entry is not limited to this configuration, nevertheless. The entry may of any configuration that can uniquely identify the merchandise and the purchase quantity.

In the example of FIG. 4, the unit can be specified from, for example, the merchandise name associated with the merchandise ID. Also in the example of FIG. 4, an item “unit” may be set in each entry.

An example of the image information output from the image-information accumulating device 11 is shown in FIG. 5.

FIG. 5 shows examples of image information acquired if the image acquisition information shown in FIG. 4 is input.

In the example of FIG. 5, each entry in the image information of is included in “merchandise ID,” “image data ID” identifier uniquely identifying the image data, “image data” representing an image of the merchandise, “quantity information,” and “scale information.”

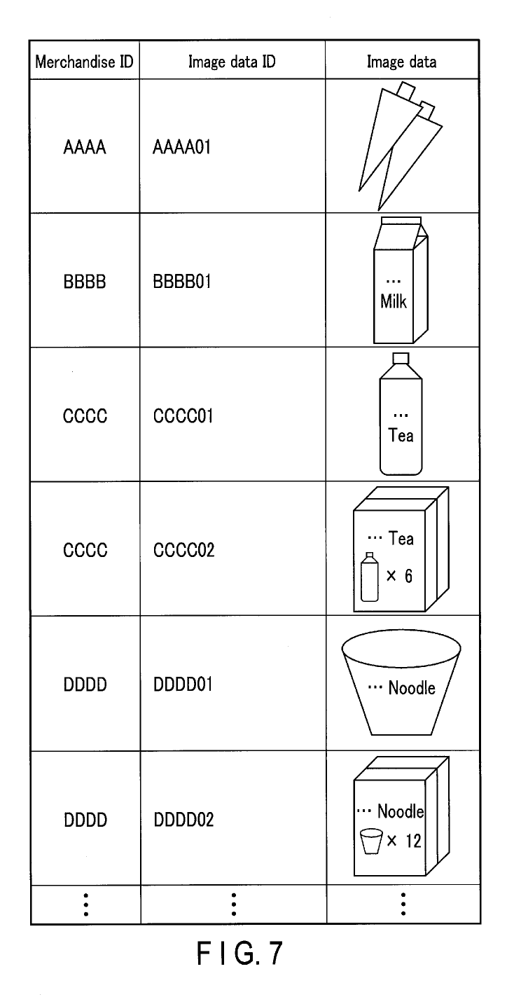

It is desired that the image data should reflect the quantity and the unit. As to, for example, the merchandise “carrot, one bag (2 pieces)” in the example of FIG. 3, an image of two bags, not images of two carrots, or an image of one set consisting of two carrots (see FIG. 7) may be used.

In some cases, a plurality of images can be acquired for the same merchandise, which differ in quantity and/or scale. Hence, there may be a plurality of such combinations as exemplified in FIG. 5.

The quantity information represents the quantity of the merchandise included in the image.

The scale information represents the ratio of the size of an image to a preset reference size. Assume that the scale of an image is 1.0 if 100 pixels express a length of 10 cm. Then, the scale of an image in which 50 pixels express a length of 10 cm is 0.5.

Here, it is assumed that image data represents an image of a bit-map type. Nonetheless, the image data is not limited to this type in this embodiment. The image data can be of any other type, so long as it can represent a vector-type image or 3D modeling data that can represent an image.

In the example of FIG. 5, the unit can be specified from the merchandise name associated with, for example, the merchandise ID. In each entry shown in FIG. 5, a unit information item may be added to each entry.

Referring back to FIG. 2 again, the merchandise-image arranging/synthesizing device 2 arranges and synthesizes the merchandise image included in the image information acquired, in accordance with the merchandise arrangement rule 30 (Step S3). How the device 2 operates will be explained later in detail, with reference to a specific example.

Next, the scale synthesis device 3 synthesizes a scale reference image from which the size of the merchandise can be determined (Step S4). How the device 3 operates will be explained later in detail, with reference to a specific example.

The image information acquiring device 1 generates image acquisition information from the purchase plan information, and makes an inquiry to the image-information accumulating device 11 and image-information generating device 12, acquiring one or more items of the image information. In the case described here, an inquiry is made to the image-information accumulating device 11 about only the merchandise for which no image information has been acquired. This embodiment is not limited to this. For example, an inquiry may be made, at the same time, to the image-information accumulating device 11 and image-information generating device 12, in order to acquire the image information.

The image-information accumulating device 11 will be described in detail.

The image-information accumulating device 11 is a device from which image information is acquired in accordance with the image acquisition information.

As shown in FIG. 1, the image-information accumulating device 11 includes a merchandise image database (DB) 111 accumulating a plurality of merchandise images, a merchandise-image quantity information database (DB) 112 accumulating the quantity of any merchandise included in each merchandise image, and a merchandise-image size information database (DB) 113 accumulating the scale information of each merchandise image.

The image-information accumulating device 11 further includes a merchandise-image size calculating device 115 configured to infer the scale information about any merchandise image, from the text information included in the merchandise information 20, such as merchandise name and text data, and/or the scale information for the merchandise image.

The merchandise-image size information DB 113 need not accumulate the scale information about all merchandise.

The image-information accumulating device 11 may not include the merchandise-image size information DB 113 or the merchandise-image size calculating device 115. If no components are provided for acquiring these scale information items, however, the devices and functions utilizing the scale information will be excluded.

In this embodiment, three DBs are used, isolated from one another. Instead, one DB may be used if it holds all necessary information.

The information accumulated in the merchandise image DB 111, the information accumulated in the merchandise-image quantity information DB 112, and the information accumulated in the merchandise-image size information DB 113 can be provided by, for example, the merchandise supplier or the net-shop manager.

The flow of the process performed in the image-information accumulating device 11 will be explained below.

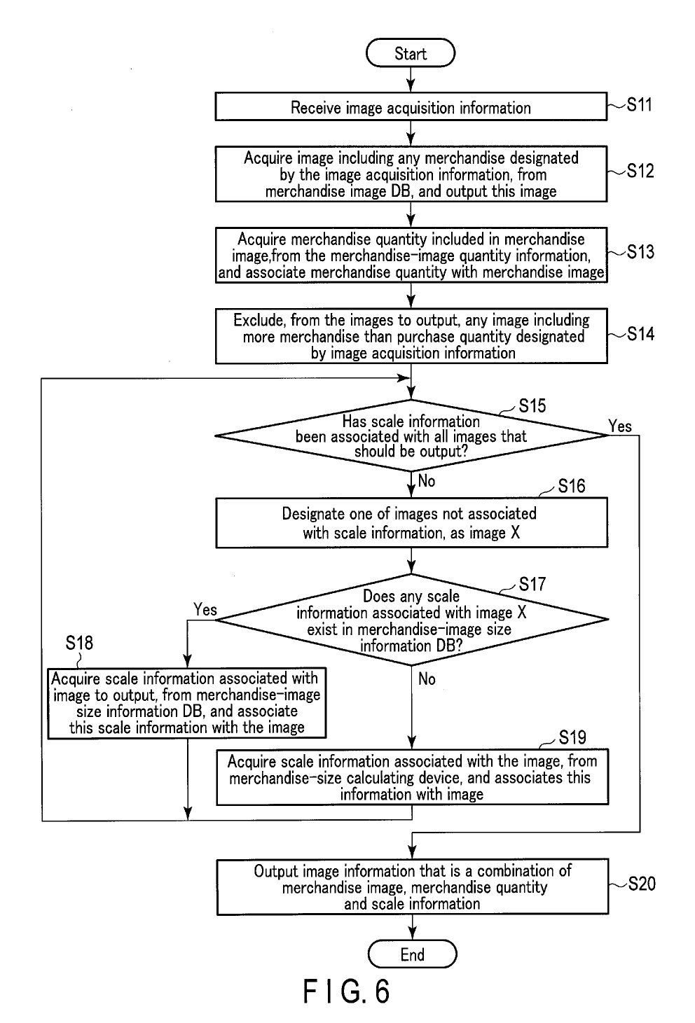

FIG. 6 is an exemplary flowchart of the process performed in the image-information accumulating device 11.

First, the image-information accumulating device 11 receives image acquisition information (see FIG. 4) (Step S11).

Next, the image-information accumulating device 11 acquires, from the merchandise image DB 111, the image including any merchandise designated by the image acquisition information so that the image may be output (Step S12). The image to output is not limited to an image of one item of merchandise only.

FIG. 7 shows an example of the description of merchandise image information stored in the merchandise image DB 111.

In the example of FIG. 7, each entry in the merchandise image DB is included in “merchandise ID,” “image data ID” and “image data.” As shown in FIG. 7, a plurality of merchandise images may exist for the same merchandise.

Then, the image-information accumulating device 11 acquires the merchandise quantity included in each merchandise image acquired, from the merchandise-image quantity information DB 112, and associates the merchandise quantity with the merchandise image (Step S13).

FIG. 8 shows exemplary information stored in the merchandise-image quantity information DB 112.

In the example of FIG. 8, the merchandise-image quantity information is included in “image data ID” of the merchandise image and “quantity information” representing the number of items of the merchandise included in the merchandise image. The image data ID associates the merchandise image with the image data.

In this case, the quantity information about all image data is held. This embodiment is not limited to this, nevertheless. If the quantity information about most merchandise images represents “1,” the quantity information may not be used for any image data associated with quantity information of “1.”

The quantity information represents the quantity of the merchandise included in the image data. Therefore, if the merchandise is one set (bag) of two carrots, the image data of quantity information “1” represents two carrots.

Referring back to FIG. 6, the image-information accumulating device 11 excludes, from the images to be output, any image including more merchandise than the purchase quantity designated by the image acquisition information (Step S14).

Next, of the merchandise images to output (i.e., those selected in Steps S15 and S16), the scale information for any image found to have scale information in the merchandise-image size information DB 113 (Yes in Step 17) is acquired from the merchandise-image size information DB 113, and is associated with the image (Step S18).

Any merchandise image to output may not have scale information in the merchandise-image size information DB 113 (No in Step S17). In this case, the merchandise-size calculating device 115 generates scale information, and the scale information is associated with the merchandise image (Step S19)

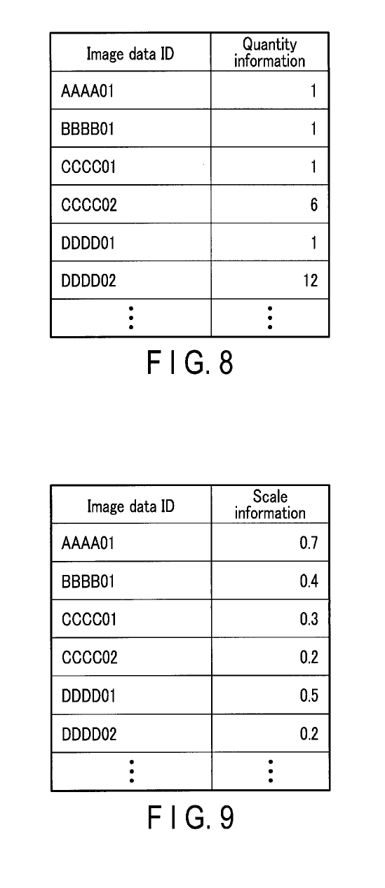

FIG. 9 shows an example of the merchandise-image size information DB 113.

In the example of FIG. 9, the merchandise-image size information is included in “image data ID” of the merchandise image and “scale information” showing the scale of the merchandise image. Thus, the image data is associated with the image data ID.

Next, the image-information accumulating device 11 outputs image information (see FIG. 5), which is a combination of the merchandise image to output, the merchandise quantity and scale information associated with the image merchandise (Step S20).

The flow of the process performed by the merchandise-image size calculating device 115 will be described below.

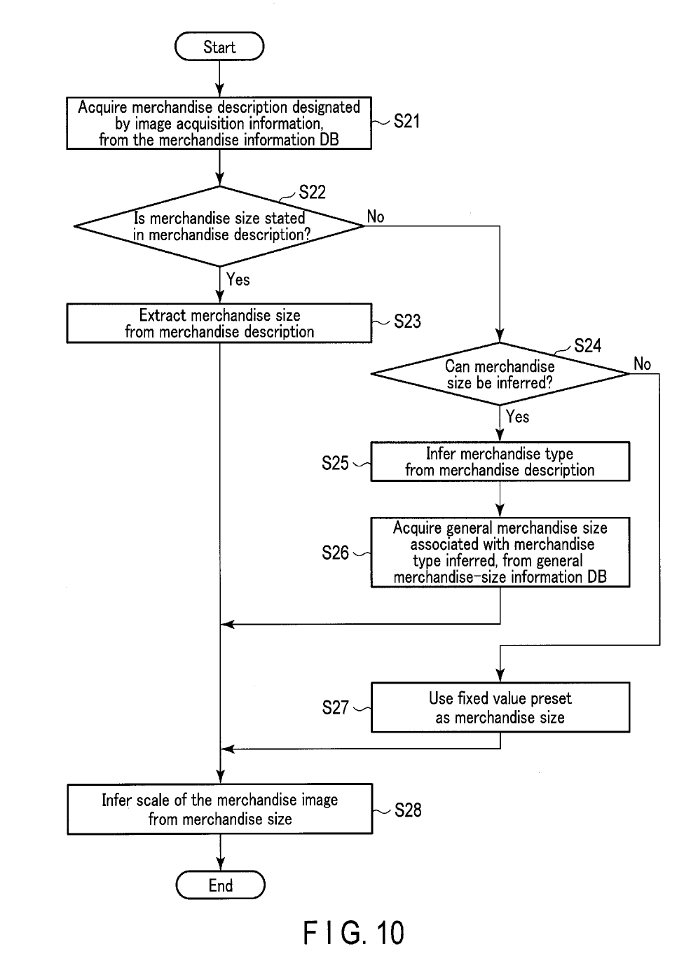

FIG. 10 is a flowchart of an exemplary process performed in the merchandise-image size calculating device 115.

First, the merchandise-image size calculating device 115 acquires the merchandise explanation designated by the image acquisition information (see FIG. 4), from the merchandise information DB (20) (Step S21).

Next, the merchandise-image size calculating device 115 determines whether the merchandise size is stated in the merchandise description acquired. If the merchandise size is stated in the merchandise description (Yes in Step S22), the merchandise size is extracted from the merchandise description (Step 23).

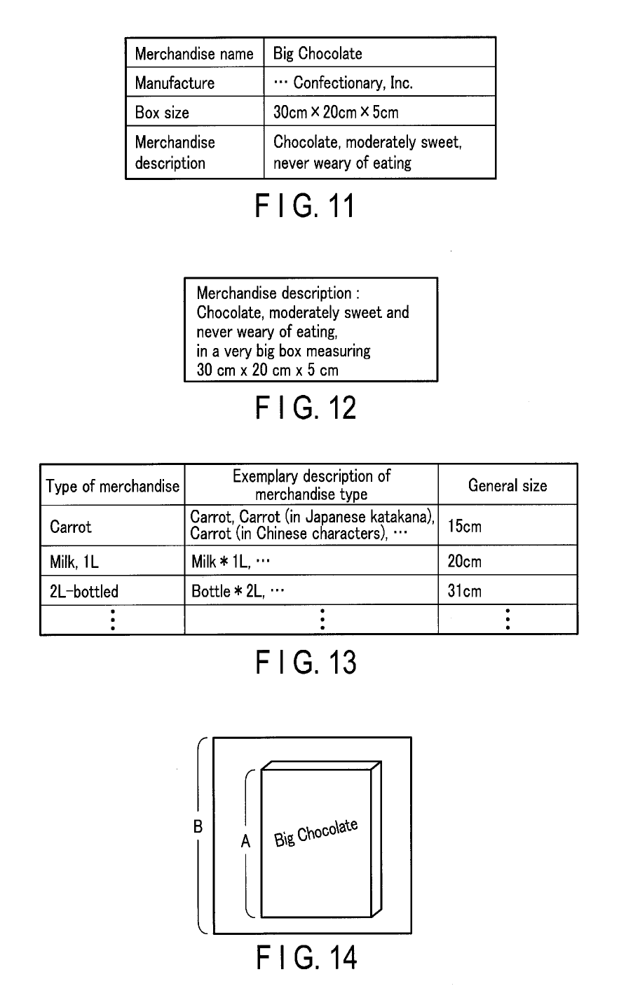

In the merchandise information 20, the merchandise size may be specified in a dedicated row as exemplified in, for example, FIG. 11. Alternatively, the merchandise size may be stated in the merchandise description as shown in FIG. 12. If the merchandise size is extracted from the information contained in the merchandise description, the numerical value or unit showing the registered length may be extracted from the information.

If the merchandise size is not stated in the merchandise description (No in Step S22), the type of any merchandise existing in the general merchandise-size information DB 114 (i.e., general merchandise size information) is inferred from the merchandise description (Step 24 and Step 25).

FIG. 13 shows an example of the description of the general merchandise-size information DB 114.

In the example of FIG. 13, each entry of the general merchandise-size information is included in “merchandise type,” “exemplary description of the merchandise type” and “general size.”

In this example, various descriptions are stored as exemplary descriptions of merchandise types. If one of the descriptions stored is identical to the merchandise type, it is considered to pertain to the merchandise type. Assume that the merchandise description reads. Then, “sweet carrots of domestic production,” the type of the merchandise is inferred as carrots since the description includes the character string of “c-a-r-r-o-t.”

In this example, symbol “*” means “and.” Assume that the merchandise description reads, “Milk produced in Hokkaido, and available in ordinary 1 L-size packs.” Then, the type of the merchandise is inferred as a 1 liter of milk, because the merchandise description includes character strings “m-i-l-k” and “1-L.”

If two or more descriptions are identical to the merchandise type, the longest description will be used. If these descriptions are character strings of the same length, the description first found identical to the merchandise type will be used.

Referring back to FIG. 10, if the type of the merchandise is inferred, the merchandise-image size calculating device 115 will acquire the general merchandise size associated with the merchandise type inferred, from the general merchandise-size information DB 114 (Step S26). If the merchandise to purchase is “leek,” the data representing the thickness or length of an ordinary leek may be acquired from the general merchandise-size information DB 114.

If the type of the merchandise cannot be inferred, a fixed value preset will be used as the merchandise size for convenience (Step S27).

The fixed value may be the average value of the merchandise put on sale.

If the merchandise size is acquired by any method described above, the scale of the merchandise image will be inferred from the merchandise size (Step S28).

As described above, the use of the merchandise information 20 is first tried, and the use of the general merchandise-size information 114 is then tried. The information 20 and the information 114 may be used in reverse order or may be used in parallel.

The scale of the merchandise image may be calculated, first by inferring the contour of an image included in the merchandise image and then by associating the length corresponding to the contour with the length of the merchandise. Alternatively, the scale of the merchandise image may be approximately calculated by associating the longest side of the image an integral multiple of the longest side of the merchandise.

Assume that the merchandise size is known as, for example, 30 cm×20 cm×5 cm for the image shown in FIG. 14, and that 30 cm is defined by the number of pixels constituting side A. Then, the scale may be calculated by the method described above. Alternatively, the scale may be calculated, on the assumption that 45 cm, i.e., 1.5 times 30 cm, is defined by the number of pixels constituting side B of the image shown FIG. 14.

The image-information accumulating device 11 may not include the merchandise-size calculating device 115. Alternatively, the merchandise-size calculating device 115 may be used or not used, as the case may be. The merchandise-size calculating device 115 will not be used if the merchandise-image size information DB 113 holds the size information for all merchandise images. If the merchandise-image size information DB 113 holds no size information, a fixed scale may be used for convenience, without using the merchandise-size calculating device 115.

In this embodiment, information has been accumulated in the general merchandise-size information DB 114 since the system was developed. Other information can be added by the merchandise supplier or the net-shop manager.

The image-information generating device 12 will be described in detail.

The image-information generating device 12 is a device configured to generate image information associated with the image acquisition information supplied to it.

The image-information generating device 12 includes a general merchandise image database (DB) 121 accumulating general merchandise images, a general merchandise image quantity information database (DB) 122 accumulating the quantities of the merchandise included in the general merchandise images, and a general merchandise image size information database (DB) 123 accumulating the scale information included in the general merchandise images.

In this embodiment, the information accumulated in the general merchandise-size information DB 114 remains stored since the since the system was developed. Other information can be added by the merchandise supplier or the net-shop manager.

The flow of the process performed in the image-information generating device 12 will be explained.

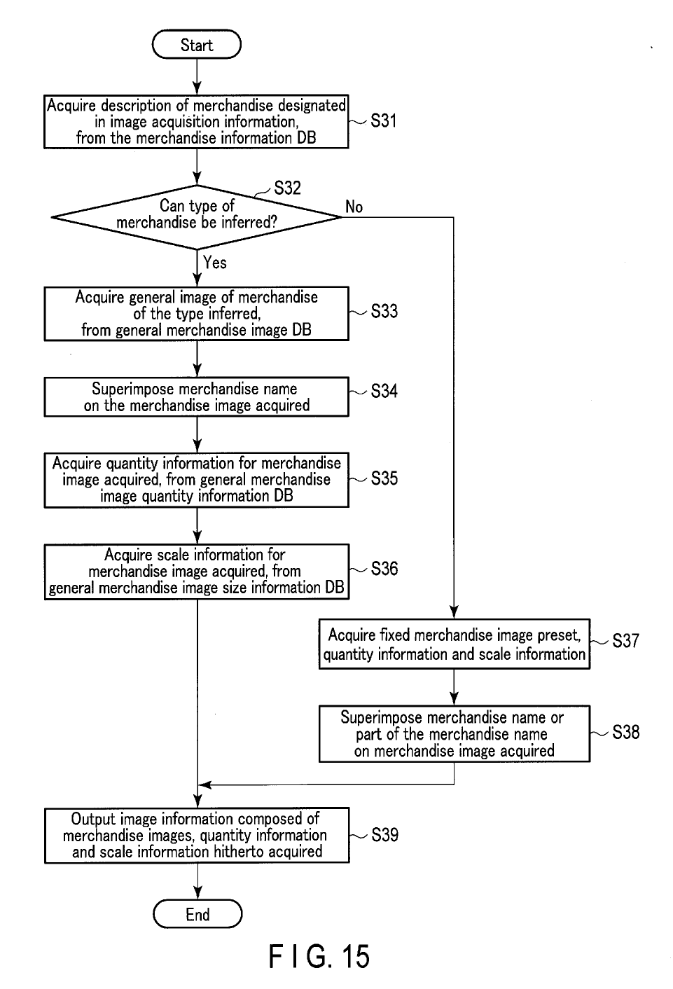

FIG. 15 is an exemplary flowchart of the process performed in the image-information generating device 12.

First, the image-information generating device 12 acquires the description of the merchandise designated in the image acquisition information (see FIG. 4), from the merchandise information DB (20) (Step S31).

If the type of the merchandise is inferred from the merchandise description (Yes in Step S32), the image-information generating device 12 acquires the general image of the merchandise of the type inferred, from the general merchandise image DB 121 (Step S33).

At this point, the image reflecting the unit should be acquired. For the merchandise name “carrot, one bag (2 pieces)” shown in FIG. 3, an image of two bags, not two carrots, may be acquired, or an image of one set included in two carrots (see FIG. 7) may be acquired. If such an image cannot be acquired, other images acquired may be synthesized, thereby providing such an image. For example, if no images, but no images, except one-carrot images, are acquired, such an image similar to the image of merchandise ID=AAAA shown in FIG. 7 may be generated.

Next, the image-information generating device 12 superimposes the merchandise name or a part of the merchandise name on the merchandise image acquired (Step S34).

Then, the image-information generating device 12 acquires the quantity information for the merchandise image acquired, from the general merchandise image quantity information DB 122 (Step S35).

Next, the image-information generating device 12 acquires the scale information for the merchandise image acquired, from the general merchandise image size information DB 123 (Step S36).

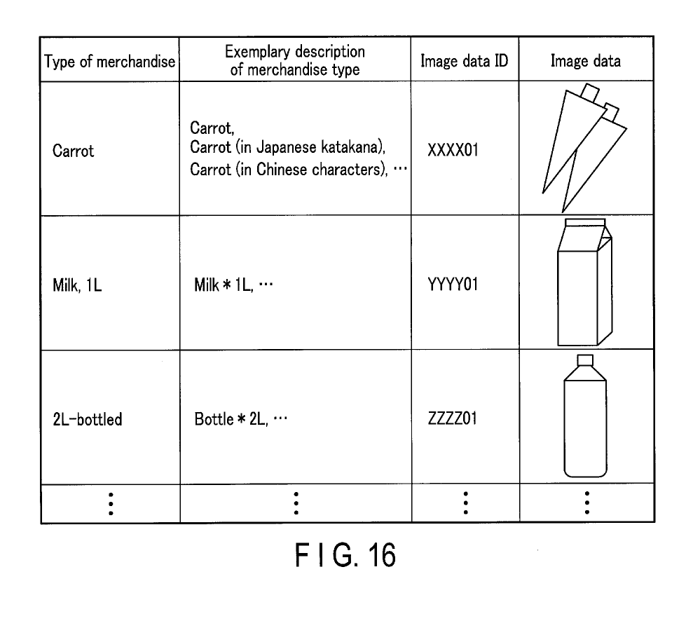

FIG. 16 shows some examples of merchandise descriptions stored in the general merchandise image DB 121.

In the example of FIG. 16, each entry of the general merchandise image DB is included in “type of the merchandise,” “description of the merchandise type,” “image data ID” and “image data.”

In this embodiment, the general merchandise image DB stores various examples of merchandise type descriptions. In order to infer the type of any merchandise from the merchandise description, a method identical to the method used in the merchandise-size calculating device 115 will be utilized.

The general merchandise image quantity information DB 122 stores information in the same form as the merchandise-image quantity information DB 112 stores it in the image-information accumulating device 11. The general merchandise image size information DB 123 stores information in the same form as the merchandise-image size information DB 113 stores it in the image-information accumulating device 11.

Referring back to FIG. 15, if the type of the merchandise cannot be inferred from the merchandise description (No in Step S32), a fixed merchandise image preset, quantity information and scale information are acquired (Step S37). The merchandise name or a part of the merchandise name is superimposed on the merchandise image acquired (Step S38).

The part of the merchandise name is superimposed on the merchandise image if the merchandise name is too long to superimpose in its entirety. Hence, a head part that can be superimposed may be cut from the merchandise name.

Finally, the image-information generating device 12 outputs the image information included in the merchandise images, quantity information and scale information hitherto acquired (Step S39).

The fixed merchandise image, the quantity information and the scale information are output for convenience if image information cannot be generated. Therefore, it is desirable to output an image clearly indicating that no image information has been generated.

The merchandise-image arranging/synthesizing device 2 will be described below in detail.

The merchandise-image arranging/synthesizing device 2 is a device configured to arrange and synthesize a plurality of images on the basis of the image acquired by the image information acquiring device 1, thereby to generate a synthesized image, i.e., image of the merchandise specified by the purchase plan information and reflecting the purchase quantity (i.e., number of pieces or units).

The merchandise is arranged in accordance with the merchandise arrangement rule 30. Here, it assumed that all merchandise to purchase is synthesized into one image of the merchandise. This embodiment is not limited to this scheme, nevertheless. The image of each item of merchandise to purchase may be generated, which reflects the purchase quantity.

The flow of the process performed in the merchandise-image arranging/synthesizing device 2 will be explained below.

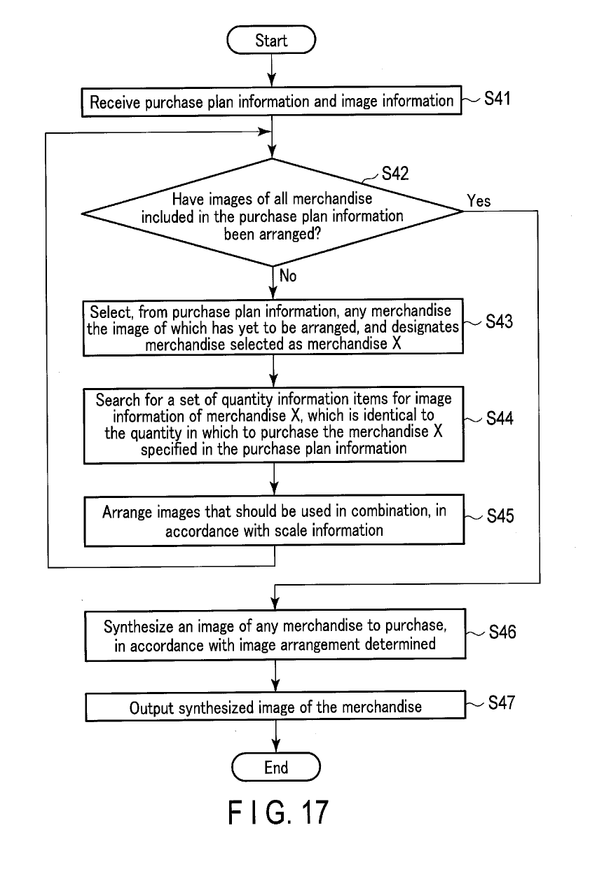

FIG. 17 is an exemplary flowchart of the process performed in a merchandise-image arranging/synthesizing device 2.

First, the merchandise-image arranging/synthesizing device 2 receives, as input data, the purchase plan information (see FIG. 3) and the image information (see FIG. 5) (Step S41). Until the images of all merchandise included in the purchase plan information are arranged (Yes in Step S42), the device 2 repeats the following sequence of operating steps.

First, the merchandise-image arranging/synthesizing device 2 selects, from the purchase plan information, any merchandise the image of which has yet to be arranged, and designates the merchandise selected as merchandise X (Step S43).

Next, the merchandise-image arranging/synthesizing device 2 seeks a set of quantity information items for the image information of merchandise X, which is identical to the quantity in which to purchase the merchandise X specified in the purchase plan information (Step S44).

The purchase plan information may be the information shown in FIG. 3. “Cup noodle” having merchandise ID=DDDD may be selected as merchandise X. The image information about the cup noodle may be the information shown in FIG. 5.

In this case, the purchase quantity or lot is “15 pieces.” Three image data items of image data ID “DDDD01,” each for “1 piece” may therefore be combined with one image data item of image data ID “DDDD02,” for “12 pieces.” The combination is not limited to this, and any other combination is possible. Which combination should be used can be determined in accordance with the merchandise arrangement rule 30.

Then, the merchandise-image arranging/synthesizing device 2 determines an arrangement of the images that should be used in combination, in accordance with the scale information (Step S45).

If a plurality of merchandise images are available, the merchandise-image arranging/synthesizing device 2 may set the same scale for these merchandise images, on the basis of the scale information items or the respective merchandise images, namely in accordance whether the images are magnified or reduced. The scale for a particular item of merchandise may be extremely smaller than that for the other merchandise (that is, the merchandise is much smaller than the other merchandise). If the scale is applied to all merchandise, the images of the other merchandise will be very small in some cases. Therefore, the scale for the particular merchandise may not be set to the same scale as for the other merchandise. Instead, the image of the merchandise may be synthesized with the image of any other merchandise in a scale of 1/x times (x is an integer greater than 1), and an image may be displayed to show that the image of the merchandise is displayed in the scale of 1/x times.

The positions at which to arrange the images can be designated in accordance with the merchandise arrangement rule 30. In the case described above, for example, the image data of image data ID “DDDD01” is magnified 1/0.5 times, arranging three images, and the image data of image data ID “DDDD02” is magnified 1/0.2 times, arranging one image.

As to the image arrangement, some measures are taken. For example, any large image is arranged at the back, not concealing other images, not mixing one with any other image. However, the method of arranging the images is not limited to these measures, and can be designated in accordance with the merchandise arrangement rule 30. That is, the merchandise arrangement rule 30 is obtained, and an image arranging method is determined from the merchandise arrangement rule 30. In this embodiment, the method is not limited to this. For example, the merchandise arrangement rule 30 may not be embedded in the device.

The sequence of operating steps described above is performed on all merchandise included in the purchase plan information.

If the arrangement of all merchandise is determined, the merchandise-image arranging/synthesizing device 2 synthesizes an image of any merchandise to purchase, in accordance with the image arrangement determined (i.e., arrangement position information) (Step S46). The device 2 then outputs the synthesized image of the merchandise (Step S47).

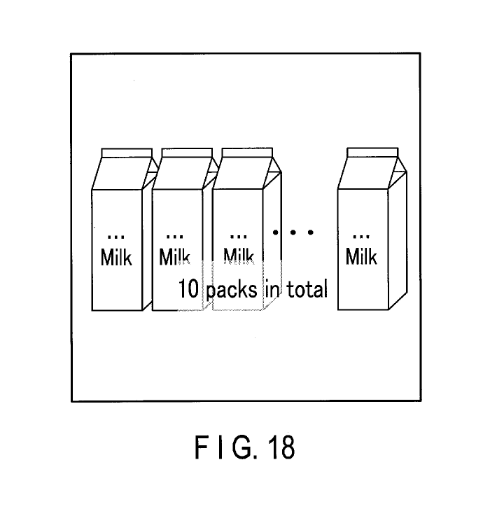

As has been described, the image of any merchandise is generated, which is purchased in a quantity identical to the purchase quantity stated in the purchase plan information. This embodiment is not limited to this scheme. The merchandise may be purchased in a quantity larger than a prescribed value. In this case, the ellipsis may be used, not showing all merchandise, or the purchase quantity or unit may be superimposed on the image of the merchandise. If the image of the merchandise is not generated, an image showing this fact may be displayed. In the image exemplified in FIG. 18, the merchandise selected is 10 packs of milk but the images of 6 packs are not shown, and ellipsis “ . . . ” is added, indicating that 6 packs are not illustrated. In the image exemplified in FIG. 18, description of “10 packs in total” is superimposed on the image of the merchandise.

The purchase plan information may include an item of merchandise sold in a specific amount, and the specific amount may not be identical to the quantity in which the merchandise should be purchased. In this case, a combination of units totaling a quantity as similar to the specific amount as possible is used.

The image arranging method is not limited to the method described above. For example, the merchandise image may be expanded or contracted in accordance with the quantity, to the size equivalent to the purchase quantity of the merchandise. Assume that the purchase plan information may include 400 g of minced pork, and only an image of 200 g of minced pork is available. Then, two images of 200 g of minced pork may be arranged, or the image of 200 g of minced pork may be expanded 2̂(⅓) times in one direction. Alternatively, both methods may be used. Instead or in addition to this, the number of trays displayed may be changed in accordance with the purchase quantity. This can help the user visually perceive the purchase quantity.

Thus far described is a technique of arranging images in a plane. This embodiment is not limited to this technique. The images may be arranged in a depth relationship in a perspective view. For example, a large item of merchandise is arranged at the back, and a small item of merchandise at the front, in accordance with the merchandise arrangement rule, so that all merchandise to purchase may be seen well. Further, merchandise rarely purchased or in an unusual quantity may be arranged at front, to make it more conspicuous than otherwise.

The merchandise images should be arranged to enable the user to understand the quantity in which to purchase each item of merchandise.

The scale-reference synthesizing device 3 will be described below in detail.

The scale-reference synthesizing device 3 synthesizes a graduated scale of a well-known type, enabling the user to conceive the actual size of any merchandise. The graduated scale may be synthesized at an edge of the screen, in consideration of the relation between the pixels and the actual size of the merchandise. Assume that 10 pixels define the length of 1 cm in an image. Then, 5-cm graduations may be drawn, at intervals of 50 pixels. An image of a tobacco package or a coin, either having a well-known size, may be synthesized and displayed, instead of such a graduated scale.

The scale-reference synthesizing device 3 may be used, or may not be used. For example, the operating mode may be switched between the drawing mode and non-drawing mode. The merchandise-image generating system may not comprise the scale-reference synthesizing device 3.

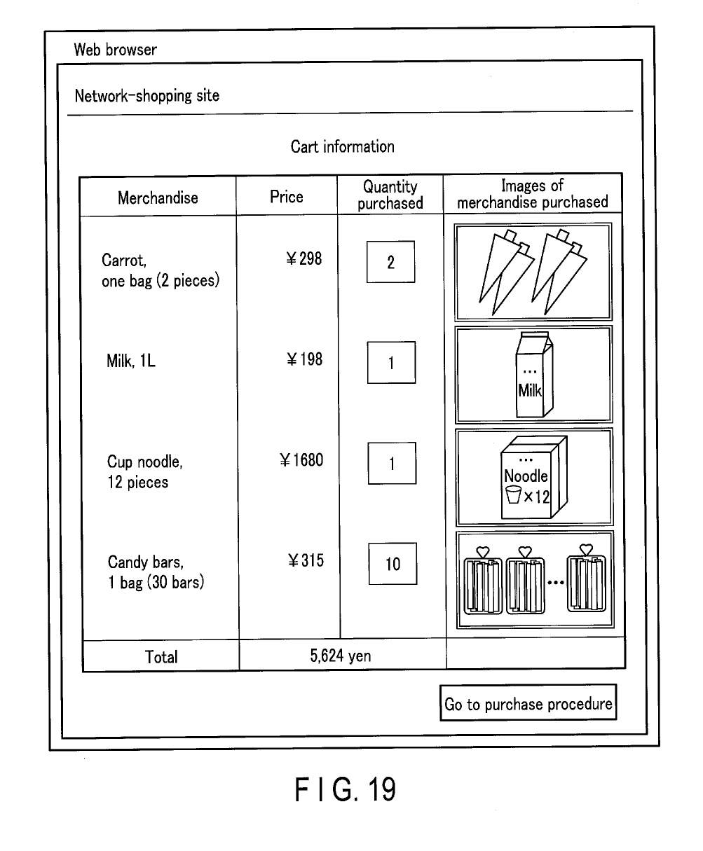

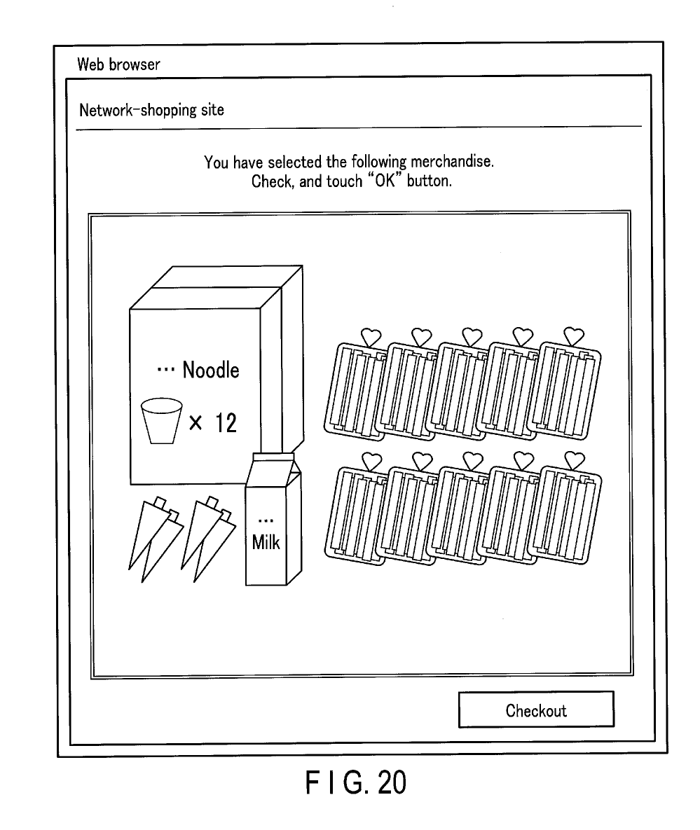

An exemplary use of the image of the merchandise to purchase will be described with reference to FIG. 19 and FIG. 20.

FIG. 19 and FIG. 20 show two examples of merchandise images generated in the merchandise-image generating system and used at a net shop operating on the web browser.

FIG. 19 is a diagram showing how the merchandise images may be utilized to purchase the merchandise, each image reflecting the quantity/units in which to purchase the merchandise. On the right of the screen, an image of each item of merchandise is displayed, reflecting the quantity/units in which to purchase the merchandise. This enables the user to understand visually the quantity in which to purchase the merchandise.

For example, the user can easily and readily understand that two bags of carrots, not two pieces, that two carrots constitute one set and that four carrots in total have been selected.

Further, the user can easily and readily understand that one set of cup noodles (or 12 pieces) has been selected, not one item of cup noodles.

Still further, the user can easily and readily understand that 10 bags of candy bars, not 10 candy bars, have been selected, because an ellipsis ( . . . ) is included in the image displayed in a small limited region.

FIG. 20 is another diagram showing how merchandise images may be utilized to purchase all merchandise the user wants. The images of all merchandise to purchase are displayed before the user places a purchase order, helping the user to notice ordering errors, if any.

In the present system, information (i.e., arrangement position information) showing where in any generated image the merchandise images are arranged can be acquired, together with the image data of the merchandise to purchase, and can then be utilized. The user can therefore confirm which merchandise he or she has selected, from the position information and the positions on the screen of FIG. 20, where the merchandise have been selected. Hence, various functions, such as displaying the detailed information about the merchandise selected, can be provided.

As has been described, this embodiment enables the user to confirm, both easily and readily, the merchandise he or she has selected on the screen.

More specifically, the type, quantity and units of any merchandise to purchase in, for example, net shopping, are clearly displayed on the screen, helping the user to notice any errors made in the purchase order. This reduces errors when ordering merchandise.

Further, the images displayed can help the user to check and confirm visually the merchandise delivered, in terms of overall quantity.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A commodity-image generating system comprising:
a receiver configured to receive selection information to specify at least one commodity selected by a user, a quantity in which to purchase the commodity and a unit of the quantity;
an acquisition unit configured to acquire at least one commodity image associated with the commodity selected in accordance with the selection information, and quantity information representing the quantity of the commodity included in the commodity image; and
a synthesizer configured to generate, on the basis of the quantity information, a synthesized image included in the commodity image, the synthesized image reflecting the quantity and the unit of the quantity.

2. The system according to claim 1, wherein if the selection information specifies a plurality of commodities, the synthesizer generates one synthesized image showing all commodities selected or a plurality of synthesized images, each showing one commodity selected.

3. The system according to claim 1, wherein the synthesizer uses at least one of a first displaying method and a second displaying method; in the first displaying method, the commodity image is displayed, except a part thereof; and in the second displaying method, the quantity and the unit are displayed, each superimposed on the commodity image.

4. The system according to claim 1, wherein the synthesizer further generates arrangement position information specifying the positions where the commodity images are arranged in the synthesized image.

5. The system according to claim 1, wherein the acquisition unit includes an accumulator configured to accumulate the images of all or some of the commodities that can be selected by the user and also information to specify the quantity of at least one of the commodities selected by the user and included in the commodity image.

6. The system according to claim 1, wherein the acquisition unit includes a generator configured to use a general commodity image, and to generate the commodity image and the quantity information.

7. The system according to claim 1, wherein the acquisition unit holds commodity images and information associated with scale information items for the respective commodity images; and the synthesizer expands or contracts the scale of each commodity image in accordance with scale information about the commodity images, unifies the scales of the commodity images, and then generates the commodity image.

8. The system according to claim 7, further comprising a scale-reference synthesizer configured to use the scale information for the commodity image, and to synthesize an image of an object used as a reference to scale and/or an image of graduation with the synthesized image.

9. The system according to claim 7, further comprising a scale information inferring unit configured to infer scale information about the commodity image on the basis of the size information included in the information about a general commodity and/or the general size information representing the actual size of the general commodity.

10. The system according to claim 1, wherein the selection information is input from a net-shop application system, and the synthesized image is supplied to the net-shop application system.

11. The system according to claim 10, wherein the commodity is a commodity selected on a commodity selecting screen related to the net-shop application system.

12. A commodity-image generating method, comprising:
receiving selection information to specify at least one commodity selected by a user, a quantity in which to purchase the commodity and a unit of the quantity;
acquiring at least one commodity image associated with the commodity selected in accordance with the selection information, and quantity information representing the quantity of the commodity included in the commodity image; and
generating, on the basis of the quantity information, a synthesized image included in the commodity image, the synthesized image reflecting the quantity and the unit of the quantity.
